(19) United States
(12) Patent Application Publication
(10) Pub. No.: US 2007/0238472 A1
(43) Pub. Date: Oct. 11, 2007

(54) METHOD AND SYSTEM FOR SMART ROUTE DIALLING TO A DESTINATION IDENTIFIER USING A TELEPHONE

(76) Inventor: James Andrew Wanless, Toronto (CA)

Correspondence Address: RIDOUT & MAYBEE;SUITE 2400, ONE QUEEN STREET EAST, TORONTO, ON, M5C3B1, US

(21) Appl. No.: 11/697,066

(22) Filed: Apr. 5, 2007

Related U.S. Application Data
(60) Provisional application No. 60/789,217, filed on Apr. 5, 2006.

(51) Int. Cl. H04Q 7/20

(52) U.S. Cl. 455/461

(57) ABSTRACT

A method, communication device and system for smart route dialling to a destination identifier using a telephone are described. In one embodiment, there is provided a method for routing a call from a communications device having at least voice capabilities, the communications device being connected to a communications network for transmitting and receiving voice data and other data over the communications network, the method comprising the steps of: selecting a destination identifier for the call, the destination identifier comprising one of: a landline telephone number, a mobile telephone number, an instant messaging (IM) address, and a session initiation protocol uniform resource indicator (SIP URI); connecting the call to a Voice over Internet Protocol (VoIP) gateway; and routing the call from the VoIP gateway to the destination identifier, comprising: if the destination identifier is a landline telephone number, routing the call to a respective landline telephone associated with the destination identifier via a public switched telephone network (PSTN), if the destination identifier is a mobile telephone number, routing the call to a respective mobile telephone associated with the destination identifier via a wireless communications network, if the destination identifier is an IM address, routing the call to a respective IM voice network (VoIM) client via a VoIM network associated with the destination identifier, and if the destination identifier is an SIP URI, routing the call to an SIP-compatible VoIP phone associated with the destination identifier via the Internet.

### RELATED APPLICATION DATA

The present application claims priority to provisional U.S. patent application Ser. No. 60/789,217, filed Apr. 5, 2006, which is incorporated herein by reference.

### TECHNICAL FIELD

The present application relates generally to telecommunications, particularly to a method and system for smart route dialling to a destination identifier using a telephone, and more particularly to a method and system for smart route dialling to a destination identifier using a mobile communications device.

### BACKGROUND

Mobile phones and other mobile communication devices typically allow a user to select the name of contact they wish to call from a local contact list or electronic address book stored on the device. If more than one number is stored for a particular contact in the contact list (e.g., work, home and mobile phone numbers), the user may select the particular number they wish to call. Upon selection of the particular number to call via user input on the graphical user interface of the device, the mobile communication device may be used to directly dial the number from contact list using the user's cellular (“wireless”) network.

Conventional contact lists for mobile communication devices do not allow the user to select SIP URIs (Session Initiation Protocol Uniform Resource Identifiers) or IM (Instant Messaging) identities for calling as these types of destination identifiers cannot be dialled through a conventional telephony network. Dial strings within the conventional telephony network are limited to numbers only, whereas SIP URI or IM identities may contain a combination of numbers, letters and other characters such as symbols. In addition, conventional contact lists for mobile communication devices allow the user to dial the contact using the user's cellular carrier network. However, it is frequently desirable to first dial a local or toll free telephone number (referred to as a gateway number) to bypass the costs associated with dialling national, mobile or international calls directly at the rates charged by the cellular network provider (commonly referred to as toll bypass).

Thus, there exits a need for a method and system for use with mobile communication devices which provides greater flexibility in the destination identifiers to be called, and which provides greater flexibility in the manner in which outgoing calls are placed.

### SUMMARY

In accordance with one embodiment of the present application, there is provided a method for routing a call from a communications device having at least voice capabilities, the communications device being connected to a communications network for transmitting and receiving voice data and other data over the communications network, the method comprising the steps of: selecting a destination identifier for the call, the destination identifier comprising one of: a landline telephone number, a mobile telephone number, an instant messaging (IM) address, and a session initiation protocol uniform resource indicator (SIP URI); connecting the call to a Voice over Internet Protocol (VoIP) gateway; and routing the call from the VoIP gateway to the destination identifier, comprising: if the destination identifier is a landline telephone number, routing the call to a respective landline telephone associated with the destination identifier via a public switched telephone network (PSTN), if the destination identifier is a mobile telephone number, routing the call to a respective mobile telephone associated with the destination identifier via a wireless communications network, if the destination identifier is an IM address, routing the call to a respective IM voice network (VoIM) client via a VoIM network associated with the destination identifier, and if the destination identifier is an SIP URI, routing the call to an SIP-compatible VoIP phone associated with the destination identifier via the Internet.

In accordance with another embodiment of the present application, there is provided a method for calling a phone number from a mobile communications device connected to a wireless communication network, the method comprising the steps of: receiving a destination telephone number for dialling from the mobile communications device, the destination telephone number being in a first format; determining a home location associated with the mobile communications device; determining a current location of the mobile communications device; and converting the destination telephone number from a first format to a second format based on the home location of the mobile communications device and the current location of the mobile communications device, wherein the second format is the E.164 international dialling format.

In accordance with further embodiments of the present application, there is provided an apparatus such as a communications device, a method for adapting the communications device, articles of manufacture such as a machine or computer readable medium having program instructions recorded thereon for practising the method of the application, as well as a computer data signal having program instructions recorded therein for practising the method of the application.

These and other aspects and features of the application will become apparent to persons of ordinary skill in the art upon review of the following detailed description, taken in combination with the appended drawings.

### BRIEF DESCRIPTION OF THE DRAWINGS

FIG. 1 is a block diagram showing a communications system for providing smart route dialling in accordance with one embodiment of the present application;

FIG. 2 is a block diagram of an example mobile communications device suitable for in the communication system of FIG. 1 in accordance with one embodiment of the present application;

FIG. 3 is a block diagram showing a mobile communications device connected to a smart route dialling network in accordance with one embodiment of the present application;

FIG. 4 is a block diagram of a protocol architecture for use in the communications system of FIG. 1 for providing smart route dialling in accordance with one embodiment of the present application;

FIG. 5 is a flowchart illustrating a method for smart route dialling a call to a landline or mobile telephone in accordance with one embodiment of the present application;

FIG. 6 is a flowchart illustrating a method for smart route dialling a call to a VoIP phone via an SIP URI in accordance with one embodiment of the present application; and

FIG. 7 is a flowchart illustrating a method for smart route dialling a call to an instant messaging (IM) address at an IM network in accordance with one embodiment of the present application.

It will be noted that throughout the drawings similar features are identified by the same reference numerals.

### DETAILED DESCRIPTION

The present application describes a method and system of smart route dialling which, in some embodiments, converts a destination phone number to be dialled by a telephone from a first format into the E.164 international dialling format. If the telephone from the call is to be connected is a mobile communications device, the destination phone number is converted based on the home location of the mobile communications device and the current location of the mobile communications device. The destination phone number may be selected from an electronic contact list or address book or entered via the device keypad of a mobile communications device from which the call is to be connected.

The present application also describes a method and system of smart route dialling which, in some embodiments, allows a user to connect to different types of voice networks (such as PSTN, wireless networks, IM voice networks, and VoIP networks) from a telephone (such as a mobile phone or mobile communications device) without the user having to choose the network type and without the user having to choose a separate method for connecting to each type of network. If the user selects to call a landline or mobile phone number, the destination phone number may be converted into the E.164 international dialling format. If the telephone from which the call is to be connected is a mobile communications device, the destination phone number is converted based on the home location of the mobile communications device and the current location of the mobile communications device. Least cost routing may be used in some embodiments for connecting to landline and mobile phone numbers. In such embodiments, the telecommunications device first connects to a VoIP gateway via a local or toll free telephone number (referred to as a gateway number) to bypass the costs associated with dialling national, mobile and/or international calls directly at the rates that would be normally charged (by a cellular network provider where telephone from the call is to be connected is a mobile communications device). This is commonly referred to as a “toll bypass”. If session initiation protocol uniform resource indicators (SIP URIs) or IM identifiers/addresses are to be called, the routing of calls through the VoIP gateway allows the connection of a call originating on a conventional telephony network (i.e., such as a cellular (wireless) network) with an SIP-enabled VoIP phone or IM client on a VoIM (Instant Messaging (IM) voice network) as such calls cannot normally be connected between these types of networks without protocol and signalling conversion provided by the VoIP gateway.

The present application also describes a graphical user interface (GUI) for enabling a user of a telecommunications device to view a list of their contacts and associated destination identifiers comprising landline telephone numbers, mobile telephone numbers, instant messaging (IM) identities/addresses and/or SIP URIs, and to enable the user to select one of the identifiers and to connect a call to the contact at the selected destination identifier without the user having to know or choose the method which will be used for calling the selected destination identifier. Where the selected destination identifier is landline or mobile phone number, least cost routing may be used to determine the optimal route for connecting the call without the user having to know the cost of using each possible combination of networks or dialling methods and choosing the least cost route.

The call may be connected in one of two ways: if the communications device on which the GUI is accessed is the user's mobile communications device and the user chooses to call from this device, it is triggered to dial to a VoIP gateway at a local access gateway number which routes the call over the public switched telephone network (PSTN), Voice over Internet Protocol (VoIP) or VoIM (Instant Messaging (IM) voice network) in accordance with the selected destination identifier, and if the selected destination identifier is a landline or mobile phone number, uses least cost routing to determine the optimal route for connecting the call.

If the user wishes to use a call back telephone (for example, because the user's mobile phone has no browser and the GUI has been accessed via a computer, or because the call back phone may result in a lower cost than originating the call from the mobile phone), the gateway calls the user's call back telephone at a designated call back number. This can be the user's mobile telephone number or any other telephone number the user decides to direct the call to prior to the call being made. Once the call is answered by the user on the call back telephone, they are the connected to the gateway. The gateway then routes the call over the public switched telephone network (PSTN), Voice over Internet Protocol (VoIP) or VoIM (Instant Messaging (IM) voice network) in accordance with the selected destination identifier, and if the selected destination identifier is a landline or mobile phone number, uses least cost routing to determine the optimal route for connecting the call.

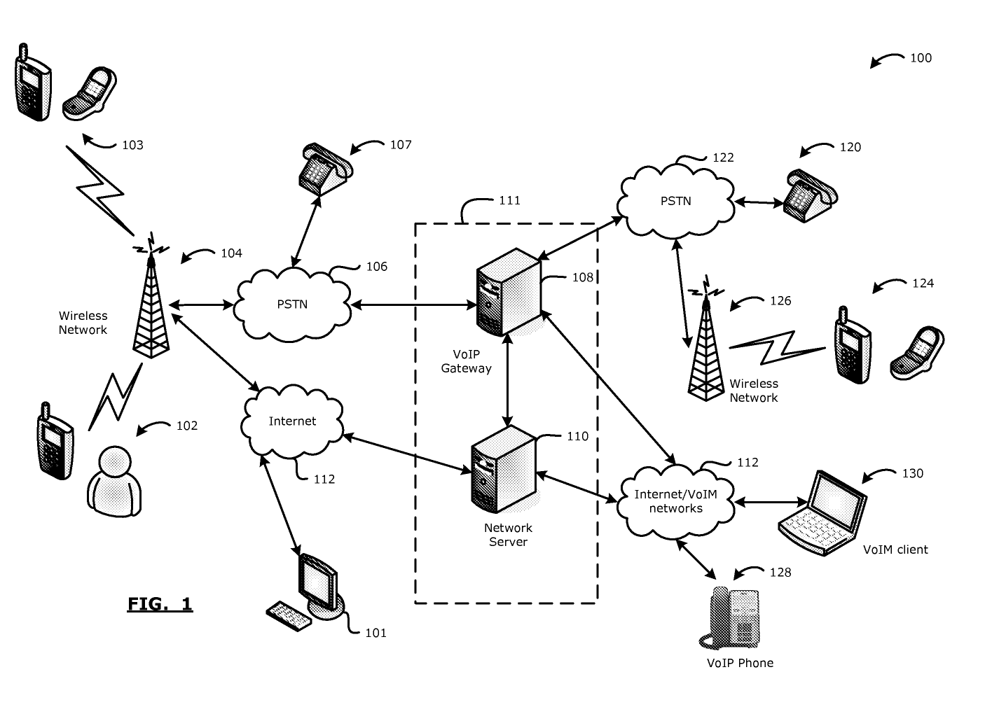

FIG. 1 is a block diagram showing a communications system 100 for providing smart route dialling in accordance with one embodiment of the present application. The communications system 100 comprises a plurality of mobile communications devices 102, 103 which are connected to a wireless voice and data network 104. The wireless network 104 also connects to landline telephones 107 via a public switched telephone network (PSTN) 106. The wireless network 104 comprises a wireless network gateway (not shown) which connects the mobile communications devices 102 to the Internet 112. User terminals and computers 101 may also be connected to the communications system 100 via the Internet 112.

The wireless network 104 typically comprises a wireless Wide Area Network (WAN) implemented as a packet-based cellular network that includes a number of base transceiver stations where each of the base stations provides wireless Radio Frequency (RF) coverage to a corresponding area or cell. The wireless WAN is typically operated by one or more cellular network service providers that sell subscription packages to users of the mobile communications devices 102. The wireless WAN comprises a number of different types of networks, for example, Mobitex Radio Network, DataTAC, GSM (Global System for Mobile Communication), GPRS (General Packet Radio System), TDMA (Time Division Multiple Access), CDMA (Code Division Multiple Access), CDPD (Cellular Digital Packet Data), iDEN (integrated Digital Enhanced Network) or various other third generation networks such as EDGE (Enhanced Data rates for GSM Evolution) or UMTS (Universal Mobile Telecommunications Systems). It will be appreciated that the wireless network types described above are provided for purposes of illustration only, and are not intended to be limiting.

The communications system 100 also comprises a smart route dialling network 111 comprising a Voice over Internet Protocol (VoIP) gateway (“gateway”) 108 and a network server 110 which are interconnected with each other. The gateway 108 is typically implemented using software. It will be appreciated that features of the gateway 108 may be integrated with those of the network server 110 even though they may be described as separate components.

The gateway 108 is connected to the wireless network 104 via the PSTN 106, and to the Internet 112 via the network server 110. Landline/PSTN telephones 107 connect to the gateway 108 via the PSTN 106. The gateway 108 is also connected to other PSTNs 122, to other wireless networks 124 via the PSTNs 122, and to SIP-enabled VoIP phones 128 and VoIP networks (not shown) via the Internet 112, and to Voice over Instant Messaging (VoIM) clients 130 running on computers or other computing devices via VoIM networks (also referred to Instant Messaging (IM) (voice) networks) such as Yahoo! Messenger™ with Voice.

The VoIP phones 128 may be hardware based VoIP phones such as provided by Nortel Networks Corporation and Cisco Systems, Inc., or software based phones or SIP clients (also referred to as VoIP softphones/SIP softphones). The SIP clients may be implemented on computer 101 or can be implemented on a suitable equipped mobile telephone with a built in SIP client (such as Nokia™ E and N series mobile phones or phones running Windows Mobile™ version 6). Example SIP clients/VoIP softphones/SIP softphones are provided by CounterPath Solutions, Inc. (www.counterpath.com) and SJ Labs, Inc. (www.sjlabs.com)

The gateway 108 receives incoming voice calls from the mobile communications devices 102 via the PSTN 106. The gateway 108 is connected to the PSTN 106 via a VoIP switch (not shown) which performs translation and negotiation functions for transforming voice data passed through the PSTN 106 into digital voice data packets, receiving voice data packets from SIP-compatible VoIP phones and networks, and translating voice data packets between different VoIP protocols if required. Suitable VoIP switches are known in the art such as those provided by Nortel Networks Corporation and Cisco Systems, Inc. Thus, the gateway 108 receives voice data from the mobile communications devices 102 in the form of SIP-compatible VoIP voice data packets via the VoIP switch.

The gateway 108 routes calls to destination identifiers corresponding to landline telephones 120 via a PSTN 122, to destination identifiers corresponding to mobile communications devices 124 via a wireless network 126 via an intermediary PSTN such as the PSTN 122. The gateway 108 also routes calls to destination identifiers corresponding to instant messaging (IM) identities (i.e., using IM addresses) to computers or other computing devices running VoIM clients 130 via the Internet 112, and to destination identifiers corresponding to SIP URIs (Session Initiation Protocol Uniform Resource Identifiers) to VoIP Phones 128 via the Internet 112.

The gateway 108 is also configured to implement least cost routing (LCR) for calls placed from the mobile communications devices 102 to landline 120 and mobile phones and mobile communications devices 124. Intelligent least cost routing (LCR) techniques are known in the art and will not be described in detail in the present application. Any suitable LCR method may be used by the gateway 108. The gateway 108 uses LCR to select the most cost-effective connection for destination identifier based on the home location of the mobile communications devices 102 and the current location of the mobile communications devices 102. Typically, rate information for the various carriers is stored in an internal routing table. This rate information is typically compared against call quality information (which may also be stored in the routing table or in a separate routing table) so as to select a routing for the call which is cost effective but which will have an acceptable level of call quality or reliability.

The network server 110 provides at least HTTP (Hypertext Transfer Protocol) and SIP (Session Initiation Protocol) connectivity. The current SIP standard is defined by Request for Comments (RFC) 3261. The network server 110 functions as a Web server and/or application server for receiving and responding to requests from the mobile communications devices 102 via a suitable Web browser such as Internet Explorer™ from Microsoft Corporation and/or a Java™ application or applet (Java™ is a trade-mark of Sun Microsystems, Inc.) on the mobile communications devices 102.

The network server 110 also functions as an SIP server for establishing an SIP session/connection with VoIP phones 128 and VoIP networks. As will be appreciated by persons skilled in the art, SIP is a peer-to-peer application-layer control (signaling) protocol for creating, modifying, and terminating sessions with one or more participants (i.e., for VoIP calls in this instance). Other supporting protocols are used for transmitting data during an SIP communication session after the session has been created. Session Description Protocol (SDP) describes streaming media initialization parameters for the purposes of session announcement, session invitation, and other forms of multimedia session initiation. The current SDP standard is defined by RFC 4566. The SIP sessions may be packet streams of the Real-time Transport Protocol (RTP) data carrying voice data packets. The current RTP standard is defined by RFC 3550.

Although reference has been made to the current version of the SIP standard and supporting protocols and the current versions thereof, this is for the purpose of explanation only and is not intended to be limiting. It will be appreciated that the method and system of smart route dialling described in the present application is intended to cover all future versions of the SIP standard and its supporting protocols, including existing and new protocols, and future modifications, variations and additions to the SIP standard and its supporting protocol.

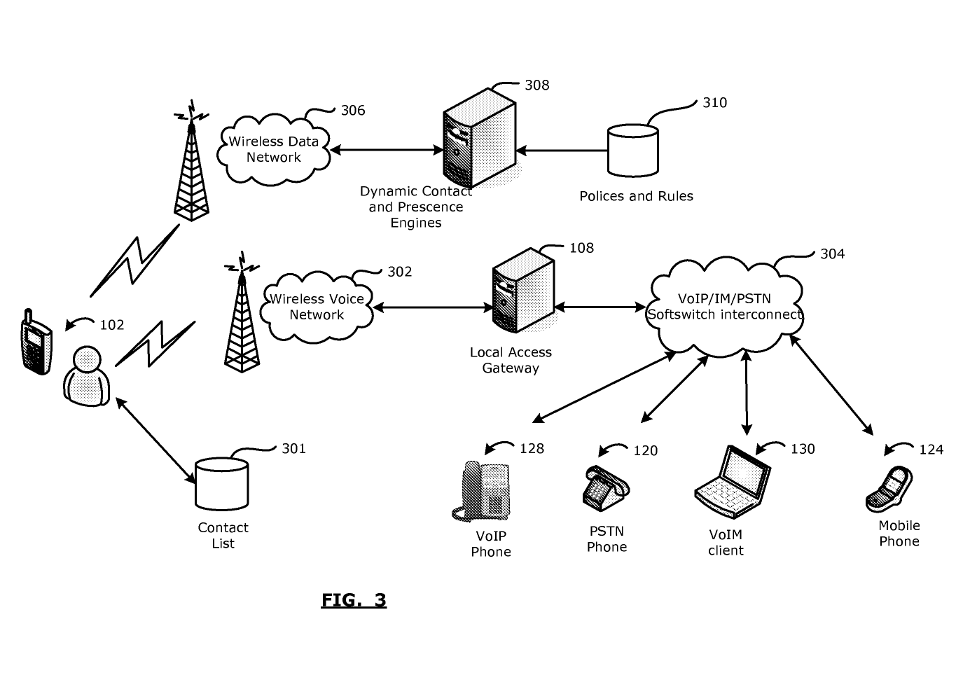

The network server 110 also implements a network interconnect softswitch 304 (FIG. 3) which interconnects and performs switching functions between the various PSTNs, VoIP, and VoIM connections to the gateway 108. The network interconnect softswitch 304 will be described in more detailed below.

After the gateway 108 has determined the optimal route for the outgoing call using LCR, the network interconnect softswitch 304 connects the call to the appropriate end point (via PSTNs/wireless networks, VoIP, and VoIM) according to the type of connection and the selected destination identifier for the outgoing call. The outgoing call may be directed to a landline telephone 120 via a PSTN 122, a mobile communications devices 124 via the wireless network 126/PSTN 122), a SIP-based VoIP phone 128 (which may be a hardware VoIP phone or an SIP client or SIP/VoIP softphone) via the Internet 112, or to a VoIM client 130 on a computer or other computing device via the Internet/VoIM network.

The network server 110 is also connected to a user account database (not shown) which stores data user account details such as user identifiers (ID), passwords or passcodes (i.e., PINs), contact lists, and user preferences. The contact lists comprise a number of contact records each comprising one or more of: a home phone number, a business a phone number, a mobile phone number, a SIP URI, and an IM identity (i.e., IM address). Each contact record may have more than one destination identifier of each type. User preferences typically include the user's “current” country and area code/city code (if any), the conditions under which the gateway 108 will dial outgoing calls (e.g., all, none, or long distance) or user's cellular (wireless) carrier network will dial outgoing calls, whether a call back number should be used, and a destination call back number. If the user's cellular (wireless) carrier network is to be used for dialling outgoing calls, the smart route dialling network 111 provides a centralized, online contact list and call dialling service. User preferences may include caller identification (ID) settings. When calling from a mobile communications device 102, available caller ID settings may be used to select between the mobile's number or another number such as business phone number, a follow-me number, or may be “Private”. A follow-me number is a phone number that, when called, is terminated onto a unified messaging or PBX (Private Branch eXchange) system which then does a lookup based on a set of user provided preferences to determine where the call should be forwarded to. These preferences can determine which number to forward the call to based on the time of day, day of week or the identity of the person making the call.

User preferences/settings may be stored on the network server 110 so that the settings are available whether the smart route dialling GUI is accessed from mobile communications devices 102 or another computing device having access to the networks server 110 such as a computer 101 with Web browser or Java™ application/applet.

The use of call back may be advantageous for several reasons. For example, the cost of calling from a given phone (such as a mobile communications device 102) may be different than that cost of receiving a call on the same phone depending on the rates charged by the respective carrier. The costs may also vary between two different phones, for example, between mobile communications device 102 and a landline phone 107 or VoIP phone 128. Additionally, the computing device on which a user selects to access the smart route dialling GUI application may not be a computer which is not equipped to handled voice calls (i.e., it may not have a SIP client or softphone), in which case a call back is required.

It will be appreciated that the system 100 shown in FIG. 1 is illustrative of a suitable communication system for implementing the smart route dialling method of the present application, and that other configurations for use with the mobile communications devices 102, 103 are possible. Though some networks such as the wireless networks 104 and 126 and PSTNs 106 and 122 have been represented as separate networks, it will be appreciated that in some embodiments and/or under some use case scenarios, one or more of the networks of each respective type may be the same. Furthermore, although individual system components are shown, it will be appreciated by persons skilled in the art that certain system components may have multiple instances, for example a plurality of local access VoIP gateways may be used to cover predefined geographic regions or cells. In addition, each gateway 108 may be connected to a plurality of PSTNs, VoIM networks and wireless networks.

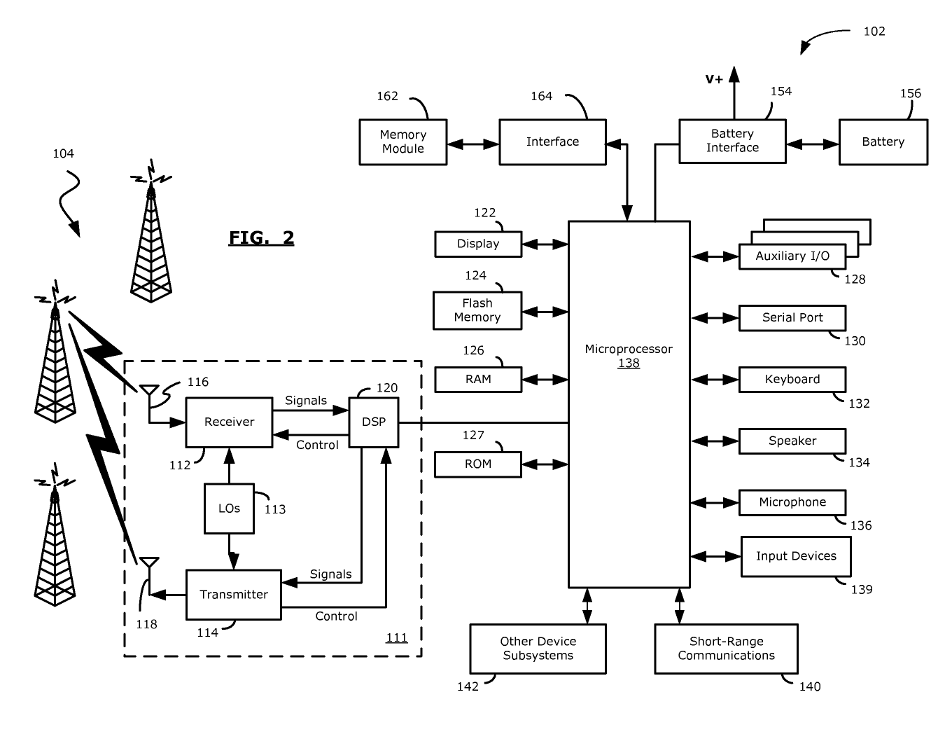

FIG. 2 is a block diagram illustrating an example mobile communications device 102 suitable for smart route dialling in accordance with one embodiment of the present application. The mobile communications device 102 is a two-way communication device having at least voice and data communication capabilities. Typically, the mobile communications device 102 is a handheld device. Depending on the functionality provided by the mobile communications device 102, it may be referred to as a mobile or cellular telephone with data/messaging capabilities, a smart phone, a personal data assistant (PDA), or a wireless Internet appliance.

The mobile communications device 102 comprises a microprocessor 138 which controls the overall operation of the mobile communications device 102 and a communication subsystem 111 connected to microprocessor 138. Communication functions, including at least voice and data communications, are performed through communication subsystem 111 which includes a receiver 112, a transmitter 114, and associated components, such as one or more antenna elements 116 and 118 (which may are commonly embedded or internal), local oscillators (LOs) 113, and a processing module such as a digital signal processor (DSP) 120. As will be apparent to those skilled in the field of communications, the particular design of the communication subsystem 111 depends on the wireless network 104 in which mobile communications device 102 is intended to operate. The mobile communications device 102 may communicate with any one of a plurality of fixed transceiver base stations within its geographic coverage area via the communication subsystem 111.

The mobile communications device 102 may send and receive communication signals over the wireless network 104 after the required network registration or activation procedures have been completed. Signals received by the antenna 116 through the wireless network 104 are input to the receiver 112, which may perform such common receiver functions as signal amplification, frequency down conversion, filtering, channel selection, etc., and analog-to-digital (A/D) conversion. A/D conversion of a received signal allows more complex communication functions such as demodulation and decoding to be performed in the DSP 120. In a similar manner, signals to be transmitted are processed, including modulation and encoding, for example, by DSP 120. These DSP-processed signals are input to the transmitter 114 for digital-to-analog (D/A) conversion, frequency up conversion, filtering, amplification and transmission over the wireless network 104 via the antenna 118. The DSP 120 not only processes communication signals, but also provides for receiver and transmitter control. For example, the gains applied to communication signals in the receiver 112 and the transmitter 114 may be adaptively controlled through automatic gain control algorithms implemented in the DSP 120.

Network access is associated with a subscriber or user of the mobile communications device 102 via a memory module 162, such as a Subscriber Identity Module (SIM) card for use in Global System for Mobile communications (GSM) networks, a Removable User Identity Module (RUIM) card for use in CDMA2000 (Code Division Multiple Access 2000) networks, or a Universal Subscriber Identity Module (USIM) card for use in UMTS (Universal Mobile Telephone Systems) networks, to be inserted in or connected to an interface 164 of the mobile communications device 102 in order to operate in the wireless network 104. Other memory modules supporting other wireless networks types may also be used. Alternatively, the memory module 162 may be a non-volatile memory which is programmed with configuration data by a service provider so that the mobile communications device 102 may operate in the wireless network 104.

The mobile communications device 102 also includes a battery interface 154 for receiving one or more rechargeable batteries 156. The battery 156 provides electrical power to the electrical circuitry in the mobile communications device 102, and the battery interface 154 provides a mechanical and electrical connection for it. The battery interface 154 is coupled to a regulator (not shown) which provides power V+ to the circuitry of the mobile communications device 102.

The microprocessor 138 is also connected to additional device subsystems such as a display 122 (e.g., a liquid crystal display (LCD), a flash memory 124, a random access memory (RAM) 126, a read-only access memory (ROM) 127, auxiliary input/output (I/O) subsystems 128, a data port such as serial port 130, a keyboard or keypad 132, a speaker 134, and a microphone 136, one or more other user input devices 139 such as a navigation or directional pad, a touch screen, a clickable trackwheel (thumbwheel) or trackball, a short-range communications subsystem 140, and any other device subsystems generally designated at 142.

The mobile communications device 102 is provided with a graphical user interface (GUI) for controlling the operation of the device. The GUI and operating system software used by the microprocessor 138 is stored in a persistent store such as flash memory 124, ROM 127 or similar storage element. Those skilled in the art will appreciate that the operating system, specific device applications, or parts thereof, may be temporarily loaded into a volatile store such as RAM 126. Other applications may be preloaded on the mobile communications device 102 for use via the GUI. The mobile communications device 102 is provided with a Web browser such as Internet Explorer™ from Microsoft Corporation or other suitable Web browser. In some embodiments, the mobile communications device 102 is provided a Java™ Runtime Environment (JRE), also known as the Java™ Virtual Machine, for running Java™ applications. Additional applications may be subsequently loaded onto the mobile communications device 102 via download over the wireless network 104, the auxiliary I/O subsystem 128, the serial port 130, the short-range communications subsystem 140, or any other suitable subsystem 142, and installed by a user in RAM 126 or persistent store such as flash memory 124 for execution by the microprocessor 138.

The microprocessor 138 also enables execution of software applications on the mobile communications device 102. A predetermined set of applications which control basic device operations, including at least data and voice communication applications, are normally installed on the mobile communications device 102 during its manufacture. The mobile communications device 102 may include a personal information manager (PIM) application having the ability to organize and manage data items relating to user such as, but not limited to, instant messaging, email, calendar events, voice mails, appointments, and task items. Naturally, one or more memory stores are available on the mobile communications device 102 and the SIM card to facilitate storage of PIM data items and other information. The PIM application has the ability to send and receive data items via the wireless network 104.

The short-range communications subsystem 140 provides for communication between the mobile communications device 102 and other systems or devices. The short-range communications subsystem 140 may comprise an infrared transceiver and/or a Bluetooth® communication module for communication with similarly-enabled systems and devices (Bluetooth® is a registered trademark of Bluetooth SIG, Inc.).

FIG. 3 is a block diagram showing the mobile communications device 102 connected to the smart route dialling network 111 in accordance with one embodiment of the present application. The voice and data streams of the mobile communications device 102 are shown separately as a wireless voice network 302 and a wireless data network 306 for the purpose of illustration, however these networks may be provided via a common wireless voice and data network 104. The user of the mobile communications device 102 has a contact list 301 which may be stored locally on the mobile communications device 102, stored on the network server 110 (FIG. 1), or may be a consolidated contact list created at runtime, for example by a Java™ application or applet, from a contact list stored locally on the mobile communications device 102 and a contact list stored on the network server 110 (FIG. 1). Alternatively, the user may have a choice via user preferences between whether a local contact list or online/consolidated contact list will be stored.

The voice data from the wireless voice network 302 is transmitted to a local access gateway 108 via a PSTN (not shown). The gateway 108 is connected to a network interconnect softswitch 304 which interconnects and performs switching functions between the various PSTNs, VoIP, and VoIM connections to the gateway 108 (not shown).

The network interconnect softswitch 304 connects voices call from the mobile communications device 102 to the appropriate end point according to the type of connection and the selected destination identifier for the outgoing call. The outgoing call may be directed to a landline telephone 120 via a PSTN 122, a mobile communications devices 124 via the wireless network 126/PSTN 122), a SIP-based VoIP phone 128 (which may be a hardware phone or an SIP client or SIP/VoIP softphone) via the Internet 112, or to a VoIM client 130 on a computer or other computing device via the Internet/VoIM network.

Other data such as text data (for example, for text messages) and presence information may be transmitted between the mobile communications device 102 and a dynamic contact and presence engine 308 via the wireless data network 306. Typically, the dynamic contact and presence engine 308 is implemented by the network server 110 (FIG. 1) and consolidates presence information to the VoIP gateway 108. The presence information may be provided by the various VoIM networks connected the VoIP gateway 108, or other sources of presence information. The presence information could relate to the user's status or availability to take a call on a landline phone, mobile phone, VoIP phone, or IM/VoIM client, and is not necessarily limited to presence information concerning the user's “online” status on an IM network.

The presence information may be used dynamically by the smart route dialling network 111 to determine which destination identifier of a contact to be called should be used based on the presence information of the contact in relation to the various destination identifier. For example, the presence information could indicate that a user is “At Work” and so the landline telephone at the contact's place of business. In this way, presence information may be used to determine the particular destination identifier of a contact to be dialled without user input. Presence information is not created by the smart route dialling network 111, but may be used as the basis for rules in smart route dialling so as to make a routing decision in respect of the destination of the call (i.e., the destination identifier) in addition to determining, once the destination identifier has been selected, the route for the call.

Typically, in order to see the presence of contacts in the smart route dialling graphical user interface (GUI), contacts must be invited to share presence information and must accept the invention and agree to share presence. Some contacts may share presence while others may not—the same goes for the user.

The dynamic contact and presence engine 308 allows presence information concerning IM contacts (buddies) to be transmitted to the mobile communications device 102 so that the user has presence information concerning their IM contacts/buddies. Instant text messaging/chat capabilities may also be provided via the wireless data network 306 as is known in the art, however this is not shown in the FIG. 3 as it is not related to the method and system of smart route dialling described in the present application. Policies and rules 310 governing the use of presence information may be applied to the dynamic contact and presence engine 308 to filter the type of presence information which may supplied to the mobile communications device 102 to ensure that the dynamic contact and presence engine 308 complies with the various policies and rules of use of the various IM networks such as MSN Messenger™, Yahoo! Messenger™ with Voice, Google Talk™, AOL Messenger™, and Gizmo Project™, enterprise IM networks/services and presence services, etc. Rules may relate to whether IM contacts have agreed to share presence information with users of the smart route dialling network 111, among other things.

It will be appreciated that using SIP three data streams may be created: a voice data stream for transmitting voice data packets compatible with SIP, including VoIP voice data packets and non-VoIP voice data packets encoded in accordance with IM network proprietary encoding protocols (which are compatible with SIP); a data stream for transmitting presence information; and a data stream for transmitting other data such a text messages.

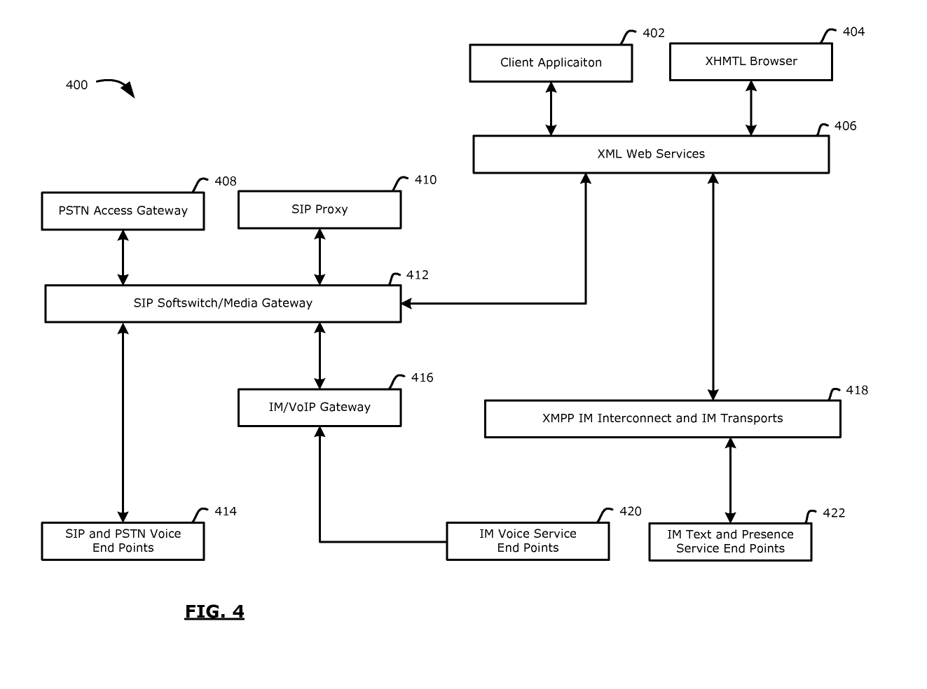

FIG. 4 is a block diagram of protocol architecture 400 for use in the communications system 100 for providing smart route dialling in accordance with one embodiment of the present application. A user of the mobile communications device 102 accesses the smart route dialling network 111 via a graphical user interface (GUI) displayed on the display 122 of the mobile communications device 102. The GUI may be provided via a Web browser 404, such as Internet Explorer™, presenting an Extensible HyperText Markup Language (XHTML) document or Java™ application or applet 402 on the display 122 of the mobile communications device 102. The XHTML browser 404 and client application 402 receive data from XML Web services 406 which are connected to an SIP Softswitch/Media Gateway 412 and XMPP Instant Message (IM) Interconnect and IM transport 418. The XMPP Instant Messaging (IM) Interconnect and IM transports 418 connect to IM Presence and Text service end points 422. Through the above-described connections, text and presence information concerning contacts stored in the contact list 301 such as IM buddies (where presence information provide via the IM/VoIM networks) may provided to the smart route dialling network GUI displayed on the mobile communications device 102.

The SIP proxy (server) 410, SIP Softswitch/Media Gateway 412, and IM/VoIP gateway 416 are elements which switch the calls and make up the network interconnect softswitch 304 (FIG. 3). They are all separate The SIP proxy (server) 410 is only used where a user is connecting to the smart route dialling network 111 using a SIP client (such as a personal computer (PC) based softphone or mobile phone with SIP client). The SIP Softswitch/Media Gateway 412 is common to types of connections to the smart route dialling network 111. The IM/VoIP gateway 416 is only used when the destination is a VoIM client.

The SIP Softswitch/Media Gateway 412 is connected to a PSTN access gateway 408 and PSTN termination end points 414 (such as landline/PSTN phones 120, mobile phones 124 via wireless networks 126 connected to PSTNs) for transmitting voice data between the mobile communications device 102 and the PSTN endpoints 414. The SIP Softswitch/Media Gateway 412 is also connected to SIP voice termination end points 414 (such as SIP-based VoIP phones 128) for transmitting voice data between the SIP-end points and the mobile communications device 102.

The SIP Softswitch/Media Gateway 412 performs two primary functions. The first function is SIP session setup to establish the route for communications. The second function is media transport. Media transport is typically only performed in the case that either one endpoint is behind a Network Address Translation (NAT) firewall, or the compression algorithm to be used for the media stream is different at the origination point or the destination (for example, the call starts as G.729a and ends as G711 or GSM). The SIP session is comprised of principal parts: signalling and media (RTP) data streams. RTP can often pass peer-to-peer in the case that each end point has an external IP address and is transmitting the RTP using the same compression algorithm.

The SIP Softswitch/Media Gateway 412 also connects to a SIP proxy (server) 410 implemented via the network server 110 which establishes the SIP sessions between the mobile communications device 102 and the VoIP phones 128. The mobile communications device 102 might not be a SIP client. If a call is connected to our softswitch through a gateway and then to a VoIP endpoint (SIP URI) then the SIP proxy establishes a session between 412 and 128 and not 102 and 128

The SIP Softswitch/Media Gateway 412 also connects to an IM/VoIP gateway 416. Currently, each IM voice network uses its own proprietary media encodation protocol. As a result, voice data packets must be transcoded to be compatible with the proprietary protocol of the destination IM network in order for a voice conversation to be passed between the mobile communications device 102 (or call back telephone) and the destination VoIM client 130 running on the destination computer or other computing device, and vice versa. The IM/VoIP gateway 416 transcodes SIP-compatible voice data packets from the VoIP gateway 108 into voice data packets that are compatible with the respective VoIM networks in accordance with the respective VoIM network encodation protocol. After transcoding the voice data packets into a format that is compatible with the respective VoIM network, the transcoded voice data packets can be transmitted to the respective VoIM network.

The IM/VoIP gateway 416 also transcodes voice data packets received from the respective VoIM networks in the proprietary encodation protocols into SIP-compatible voice data packets for transmission to the VoIP gateway 108 and from the gateway 108 to the caller via the mobile communications device 102 or call back telephone. If a standard for VoIM voice data packets is achieved, the transcoding step may be omitted provided that standard voice data packets are used by the smart route dialling network 111 and the connected VoIM/IM networks.

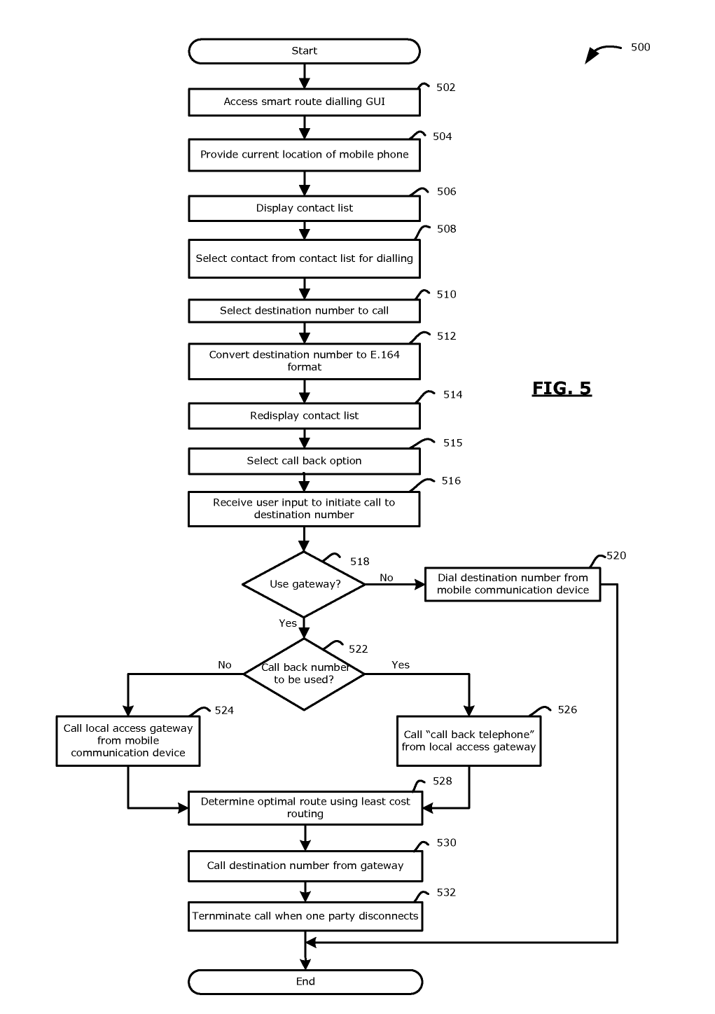

Referring now to FIG. 5, example operations 500 of a smart route dialling method in accordance with one embodiment of the present application will be described. The operations 500 illustrate the dialling of a landline or mobile telephone phone number.

In a first step 502, a user of the mobile communications device 102 accesses the smart route dialling GUI via a Web browser (for example, via a displayed Extensible HyperText Markup Language (XHTML) document) or Java™ application or applet on the mobile communications device 102. The user logs into the smart route dialling GUI application which provides access to a number of resources via the network server 110, including a smart route dialling function to enable communications. The user logs in by providing a valid user name and password present in the Web browser on the mobile communications device 102 or using a Java™ application on the mobile communications device 102. A user name and password validation check loop is performed but not shown in FIG. 5 for convenience. After the first login, the login information may be stored locally on the mobile communications device 102 for access during subsequent logins so that this information need not be provided on subsequent logins.

Next, in optional step 504 after successfully logging into the smart route dialling network 111, the user provides their current geographic location if their location is not the default or “home” location stored in the user account profile. The user may be prompted to confirm their current location is the home location or requested to enter the current location. It will be appreciated that the current location need not be provided in this order and can be provided at another stage in the operations 500 so long as it is provided before the destination telephone phone number is processed in step 512. Alternatively, depending on local wireless network capabilities, the smart route dialling network 111 may be configured to determine the current location of on the mobile communications device 102 using location information provided by location based servers (not shown) of the wireless network 104. Alternatively, the smart route dialling network 111 may be configured to determine the current location of on the mobile communications device 102 using location information provided by a Global Positioning System (GPS) or an assisted GPS. Assisted GPS is a service provided by many wireless telecommunications carriers in which a combination of GPS information obtained from satellites is combined with triangulation information from transceiver base stations of the wireless network 104 to determine the location of the mobile communications device 102.

Next, in step 506 the user's contact list 301 is presented on the display of the mobile communications device 102 using the Web browser or using a Java™ application or applet. As described above, the contact list 301 may be stored locally on the mobile communications device 102, stored on the network server 110 (FIG. 1), or may be a consolidated contact list created at runtime, for example by a Java™ application or applet, from a contact list stored on the locally on the mobile communications device 102 and a contact list stored on the network server 110 (FIG. 1). The displayed contact list will show contact records for the user's stored contacts, including instant messaging buddies on IM networks such as MSN Messenger™, Google Talk™, Yahoo! Messenger™ with Voice, AOL Messenger™, and Gizmo Project™. Each contact record comprises one or more of: a home phone number, a business a phone number, a mobile phone number, a SIP URI, and an IM identity. Typically, the electronic address book or contact list will provide an option to search for any contact stored in their electronic address book, typically by full or partial name or phone number. It will be appreciated that the contact list 301 may be scrollable or expandable to accommodate a large number of contacts or may span several linked pages/documents in the XHTML document or Java™ application/applet.

Next, in step 508 the user selects a specific contact they wish to call from the contact list 301.

Next, in step 510 the user selects the specific destination telephone number they wish to call from the multiple numbers they may have stored for the contact from the contact list 301 using the keypad 132 or other input devices 139 on the mobile communications device 102.

Next, in step 512 destination telephone number is converted into the international dialling format specified by the E.164 international dialling format based on the following factors: (1) the user's home country code, and area or city code if any; (2) the user's current location (country code, and area or city code if any); and (3) a comparison to a database of all known country code, area/city codes and local exchange codes worldwide. If no area code (or city code) is provided for the destination telephone number in the contact list 301, if required, the destination telephone number will be assumed to have the same country code and area/code as the user's “home” location.

It will be appreciated by persons skilled in the art that every country has both a country calling code used to dial into a country, and an international call prefix or international access code used to dial out of the country. The ITU-T (International Telecom Union-Telecommunication) has approved “00” as the general standard which has been implemented by a large number of countries but there are exceptions, notably North America which has implemented the North American Numbering Plan (NANP) which is an integrated telephone numbering plan of 24 countries and territories: the United States and its territories, Canada, Bermuda, and 16 Caribbean nations. The NANP provides a system of three-digit area codes and seven-digit telephone numbers that direct telephone calls to particular regions.

E.164 is an ITU-T Recommendation which defines the international public telecommunication numbering plan used in PSTN and wireless voice networks. E.164 defines the format of telephone numbers, specifying that E.164 telephone numbers can have a maximum of 15 digits and are usually written with a “+” prefix. Using the E.164 format obviates the need to use a long distance prefix when dialling. As calls are connected via a local access gateway at a local access gateway number dialled by the user or via call back, an international call is not placed so the use of an international call prefix such as “011”, “00” or “+” is not required. Formatting the destination telephone number into the E.164 format allows call to be passed via carrier partner(s) through the carrier networks.

Next, in optional step 514 the network server 110 re-displays the contact list 301 in the Web browser or Java™ application/applet with the destination telephone number being associated with an embedded link. The embedded link, which is not visible to the user, is invokable (executable) by the user via respective user input via the keypad 132 or other input device 139. Alternatively, the E.164 formatted destination telephone number may be stored in memory (typically on the network server 110) until call time when the user instructions the mobile communications device 102 to dial the call via respective user input via the keypad 132 or other input device 139.

Next, in optional step 515 a user may select whether a call back telephone number is to be used. This step may be determined via user preferences stored in the user profile or at call time, depending on the embodiment.

Next, in step 516 the mobile communications device 102 receives instructions to initiate the call to destination telephone number via respective user input via the keypad 132 or other input device 139, such as selecting the destination telephone number and invoking the embedded link.

Next, in step 518 it is determined if the destination telephone number is be dialled using the gateway 108 or dialled directly by the mobile communications device 102 via the wireless network 104. This step may be determined via user preferences stored in the user profile or at call time, depending on the embodiment. If the call is to be dialled directly by the mobile communications device 102, operations 500 proceed to step 520. If the call is to be dialled directly via the gateway 108, operations 500 proceed to step 522.

Next, in step 520 the user input to the initiate the call will instruct the mobile communications device 102 to dial the E.164 formatted destination telephone number directly using the wireless network 104. The call is then routed via the wireless network 104 to a landline/PSTN phone 107 via the PSTN 106 or a mobile phone or mobile communications device 103 via the wireless network 104 in accordance with the destination telephone number (see FIG. 1). In this use case scenario, the smart route dialling network 111 provides a call formatting service but does not route the call via the gateway 108.

Next, in step 522 the network server 110 determines how the mobile communications device 102 will connect to the smart route dialling network 111 based on user preferences. If a call back number is to be used, operations 500 proceed to step 526. If no call back number is to be used, operations 500 proceed to step 524.

In step 524, user input to initiate the call to the destination telephone (such as selecting the displayed destination telephone number and therefore invoking the hidden embedded link) will send a signal to the network server 110 which in turn sends a signal to the local access gateway 108 instructing the gateway 108 that an inbound call will be received from the mobile communications device 102 initiating the call at the gateway number, providing the destination telephone number which the user has selected, and instructing the gateway 108 to call the destination telephone number once the inbound call has been received. The mobile communications device 102 will also be instructed to call a local access gateway 108 at a gateway number via the wireless network 104. The gateway number is determined based on the user's current location at the time the call is initiated and is determined by the smart route dialling network server 110 based on internal algorithms.

Next, in step 526 if a call back number is to be used, the gateway 108 calls the user at the designated call back telephone number specified in the user preferences stored in the user profile or provided at call time. The call back telephone number may be any telephone number the user decides to direct the call to prior to the call being made, for example, the call back telephone number may be a telephone phone associated with the mobile communications device 102, another mobile phone number or mobile communications device, a landline/PSTN phone, or a VoIP phone. Once the call back is answered by the user at the call back telephone number, the call is connected to the gateway 108. The call is now connected to the gateway in a format which allows for connection to any of the networks supported by the gateway 108.

Next, in step 528 once the user is connected to local access gateway 108 via the mobile communications device 102 or call back telephone, the gateway 108 uses a method of least cost routing (LCR) to determine which available network route is optimal (i.e., which route is the most cost effective, the most reliable, or which has the “optimal” combination of cost and reliability ratings in accordance with various cost and quality parameters and calculated using internal algorithms) to determine how to route the call to the destination telephone number.

Next, in step 530 the gateway 108 will initiate a second call to the destination telephone number selected by the user via the determined least cost route. The inbound call from the mobile communications device 102 is bridged with the second call to the destination telephone number via the local access gateway 108. The call is connected to the network interconnect softswitch via the gateway 108 but is bridged by the network interconnect softswitch 304 (FIG. 3) (SIP Softswitch/Media Gateway 412). The call is connected to the destination telephone number via the network interconnect softswitch 304.

Next, in step 532 the call is automatically terminated by the smart route dialling gateway 108 when one party to hangs up or ends the call and the operations 600 end.

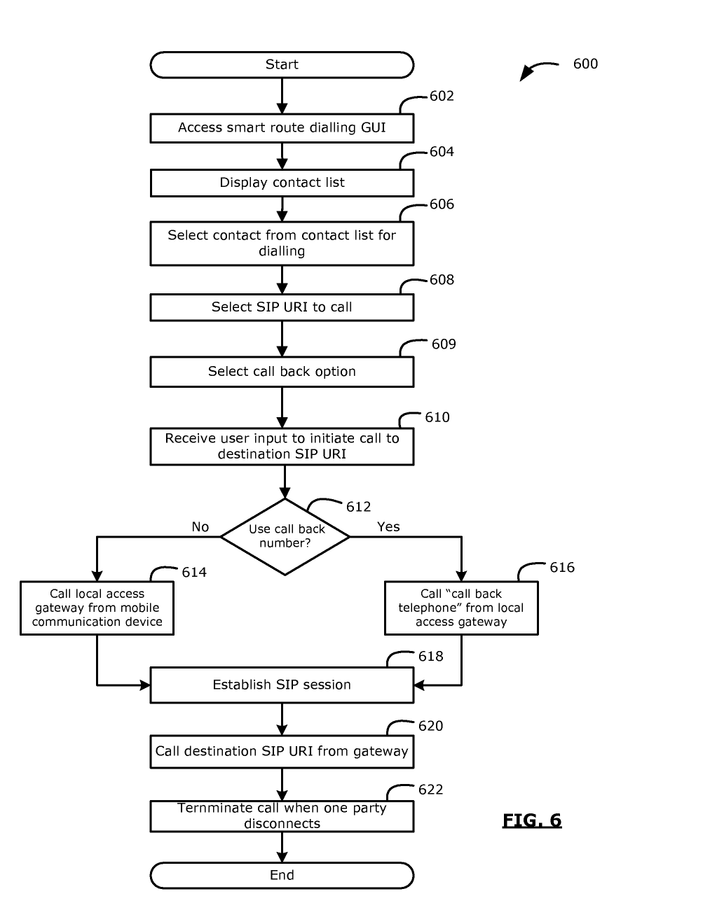

Referring now to FIG. 6, example operations 600 of a smart route dialling method in accordance with another embodiment of the present application will be described. The operations 600 illustrate the dialling of an SIP-based VoIP phone number.

In a first step 602, a user of the mobile communications device 102 accesses the smart route dialling GUI via a Web browser (for example, via a displayed Extensible HyperText Markup Language (XHTML) document) or Java™ application or applet on the mobile communications device 102. The user logs into the smart route dialling GUI application which provides access to a number of resources via the network server 110, including a smart route dialling function to enable communications. The user logs in by providing a valid user name and password present in the Web browser on the mobile communications device 102 or using a Java™ application on the mobile communications device 102. A user name and password validation check loop is performed but not shown in FIG. 6 for convenience. After the first login, the login information may be stored locally on the mobile communications device 102 for access during subsequent logins so that this information need not be provided on subsequent logins.

Next, in step 604 the user's contact list 301 is presented on the display of the mobile communications device 102 using the Web browser or using a Java™ application or applet. As described above, the contact list 301 may be stored locally on the mobile communications device 102, stored on the network server 110 (FIG. 1), or may be a consolidated contact list created at runtime, for example by a Java™ application or applet, from a contact list stored on the locally on the mobile communications device 102 and a contact list stored on the network server 110 (FIG. 1). The displayed contact list will show contact records for the user's stored contacts, including instant messaging buddies on IM networks such as MSN Messenger™ Google Talk™ and Gizmo Project™. Each contact record comprises one or more of: a home phone number, a business a phone number, a mobile phone number, a SIP URI, and an IM identity. Typically, the electronic address book or contact list will provide an option to search for any contact stored in their electronic address book, typically by full or partial name or phone number. It will be appreciated that the contact list 301 may be scrollable or expandable to accommodate a large number of contacts or may span several linked pages/documents in the XHTML document or Java™ application/applet.

The network server 110 may display the contact list 301 in the Web browser or Java™ application/applet with the destination SIP URI being associated with an embedded link. The embedded link, which is not visible to the user, is invokable (executable) by the user via respective user input via the keypad 132 or other input device 139.

Next, in step 606 the user selects a specific contact they wish to call from the contact list 301.

Next, in step 608 the user selects a SIP URI of the contact from the contact list 301 using the keypad 132 or other input devices 139 on the mobile communications device 102. It will be appreciated that SIP URIs have a general format of sip:x@y:Port, where x=Username and y=host (domain or IP). For example, a valid SIP URI could be sip:heather.barron@212.123.1.213 or sip: heather.barron@sampledomain.com.

Next, in optional step 609 a user may select whether a call back telephone number is to be used. This step may be determined via user preferences stored in the user profile or at call time, depending on the embodiment.

Next, in step 610 the mobile communications device 102 receives instructions to initiate the call to the selected (“destination”) SIP URI via respective user input via the keypad 132 or other input device 139, such as selecting the SIP URI and invoking an embedded link.

Next, in step 612 the network server 110 determines if a call back number is to be used. If a call back number is to be used, operations 600 proceed to step 616. If no call back number is to be used, operations 600 proceed to step 614.

Next, in step 614 the user input to initiate the call to the destination SIP URI (such as selecting the displayed SIP URI and therefore invoking the hidden embedded link) will send a signal to the network server 110 which in turn sends a signal to the local access gateway 108 instructing the gateway 108 that an inbound call will be received from the mobile communications device 102 initiating the call at the gateway number, providing the destination SIP URI which the user has selected, and instructing the gateway 108 to call the destination SIP URI once the inbound call has been received. The mobile communications device 102 will also be instructed to call a local access gateway 108 at a gateway number via the wireless network 104. The gateway number is determined based on the user's current location at the time the call is initiated and is determined by the smart route dialling network server 110 based on internal algorithms.

Next, in step 616 if a call back number is to be used, the gateway 108 calls the user at the designated call back telephone number specified in the user preferences stored in the user profile or provided at call time. The call back telephone number may be any telephone number the user decides to direct the call to prior to the call being made, for example, the call back telephone number may be a telephone phone associated with the mobile communications device 102, another mobile phone number or mobile communications device, a landline/PSTN phone, or a VoIP phone. Once the call back is answered by the user at the call back telephone number, the call is connected to the through the gateway 108 to the softswitch 304. The call is now in a standard format which allows for connection to any of the networks supported by the softswitch 304 (412).

Next, in step 618 once the user is connected to local access gateway 108, the network server 110 establishes an SIP session between the mobile communications device 102 or call back telephone, and the VoIP phone 128 corresponding to the destination SIP URI. The network interconnect softswitch 304 (FIG. 3) performs signalling and protocol conversion to connect the mobile communications device 102 and SIP-based VoIP phone 128. The call is now connected to the gateway in a format which allows for connection to any of the networks supported by the gateway 108.

Next, in step 620 the gateway routes the call to the destination SIP URI. The call is connected to the network interconnect softswitch 304 via the gateway 108 but is bridged by the network interconnect softswitch 304 (FIG. 3) (SIP Softswitch/Media Gateway 412). The call is connected to the destination telephone number via the network interconnect softswitch 304.

Next, in step 622 the call is automatically terminated by the smart route dialling gateway 108 when one party to hangs up or ends the call and the operations 600 end.

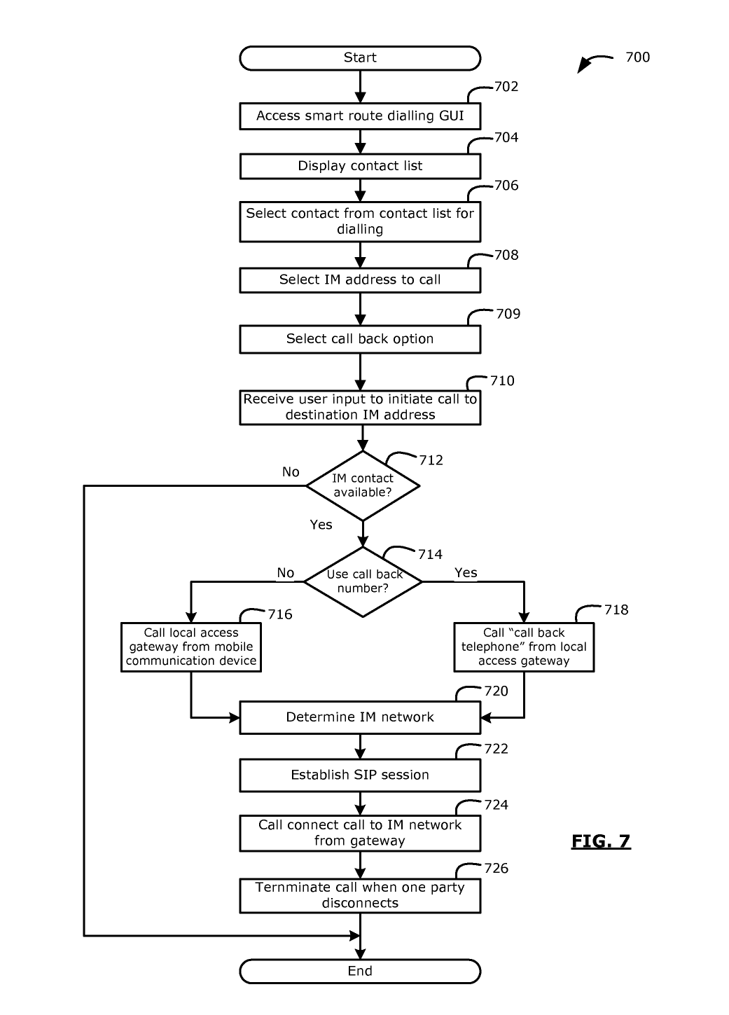

Referring now to FIG. 7, example operations 700 of a smart route dialling method in accordance with another embodiment of the present application will be described. The operations 700 illustrate the dialling of an IM contact or “buddy” of an Instant Messenger voice network such as MSN Messenger™, Yahoo! Messenger™ with Voice, Google Talk™, AOL Messenger™, and Gizmo Project™, or enterprise IM network, etc.

In a first step 702, a user of the mobile communications device 102 accesses the smart route dialling GUI via a Web browser (for example, via a displayed Extensible HyperText Markup Language (XHTML) document) or Java™ application or applet on the mobile communications device 102. The user logs the smart route dialling GUI application which provides access to a number of resources via the network server 110, including a smart route dialling function to enable communications. The user logs in by providing a valid user name and password present in the Web browser on the mobile communications device 102 or using a Java™ application on the mobile communications device 102. A user name and password validation check loop is performed but not shown in FIG. 7 for convenience. After the first login, the login information may be stored locally on the mobile communications device 102 for access during subsequent logins so that this information need not be provided on subsequent logins.

Next, in step 704 the user's contact list 301 is presented on the display of the mobile communications device 102 using the Web browser or using a Java™ application or applet. As described above, the contact list 301 may be stored locally on the mobile communications device 102, stored on the network server 110 (FIG. 1), or may be a consolidated contact list created at runtime, for example by a Java™ application or applet, from a contact list stored on the locally on the mobile communications device 102 and a contact list stored on the network server 110 (FIG. 1). The displayed contact list will show contact records for the user's stored contacts, including instant messaging buddies on IM networks such as MSN Messenger™, Google Talk™ and Gizmo Project™. Each contact record comprises one or more of: a home phone number, a business a phone number, a mobile phone number, a SIP URI, and an IM identity. Typically, the electronic address book or contact list will provide an option to search for any contact stored in their electronic address book, typically by full or partial name or phone number. It will be appreciated that the contact list 301 may be scrollable or expandable to accommodate a large number of contacts or may span several linked pages/documents in the XHTML document or Java™ application/applet.

The network server 110 may display the contact list 301 in the Web browser or Java™ application/applet with the destination SIP URI being associated with an embedded link. The embedded link, which is not visible to the user, is invokable (executable) by the user via respective user input via the keypad 132 or other input device 139.

Next, in step 706 the user selects a specific contact they wish to call from the contact list 301.

Next, in step 708 the user selects an IM contact from the contact list 301 using the keypad 132 or other input devices 139 on the mobile communications device 102. It will be appreciated that IM contact addresses are usually in the format user.name@instantmessagindnetworkdomain.com

Next, in optional step 709 a user may select whether a call back telephone number is to be used. This step may be determined via user preferences stored in the user profile or at call time, depending on the embodiment.

Next, in step 710 the mobile communications device 102 receives instructions to initiate the call to the IM contact via respective user input via the keypad 132 or other input device 139, such as selecting the IM contact and invoking an embedded link.

Next, in step 712 the smart route dialling network 111 determines the availability of the contact to receive the call by checking presence information corresponding to the IM address on the dynamic contact and presence engine 308 (FIG. 3). If the IM contact is not online or if their presence information indicates they are otherwise not available, operations 700 end as the call cannot be placed. If the IM contact is online and their presence information indicates they are available to take a call, operations 700 proceed to step 714.

Next, in step 714 the network server 110 determines if a call back number is to be used. If a call back number is to be used, operations 700 proceed to step 718. If no call back number is to be used, operations 700 proceed to step 716.

Next, in step 716 the user input to initiate the call to the destination IM address (such as selecting the displayed IM address and therefore invoking the hidden embedded link) will send a signal to the network server 110 which in turn sends a signal to the local access gateway 108 instructing the gateway 108 that an inbound call will be received from the mobile communications device 102 initiating the call at the gateway number, providing the destination IM address which the user has selected, and instructing the gateway 108 to connect to the destination IM address once the inbound call has been received. The mobile communications device 102 will also be instructed to call a local access gateway 108 at a gateway number via the wireless network 104. The gateway number is determined based on the user's current location at the time the call is initiated and is determined by the smart route dialling network server 110 based on internal algorithms.

Next, in step 718 if a call back number is to be used, the gateway 108 calls the user at the designated call back telephone number specified in the user preferences stored in the user profile or provided at call time. The call back telephone number may be any telephone number the user decides to direct the call to prior to the call being made, for example, the call back telephone number may be a telephone phone associated with the mobile communications device 102, another mobile phone number or mobile communications device, a landline/PSTN phone, or a VoIP phone. Once the call back is answered by the user at the call back telephone number, the call is connected to the gateway 108. The call is now in a standard format which uses the SIP. Once the call back is answered by the user at the call back telephone number, the call is connected to the through the gateway 108 to the network interconnect softswitch 304 (FIG. 3). The call is now in a standard format which allows for connection to any of the networks supported by the softswitch 304 (412). The call is connected to the network interconnect softswitch 304 via the gateway 108 but is bridged by the network interconnect softswitch 304 (FIG. 3) (SIP Softswitch/Media Gateway 412). The call is connected to the destination telephone number via the network interconnect softswitch 304.

Next, in step 720 once the user is connected to the local access gateway 108, the network server 110 determines which IM network the call is destined for, typically by an analysis of the destination IM address. For example, if the destination IM address contains “msn” or “hotmail” this indicates the Microsoft Messenger™ network Similarly, if the address contains “Yahoo” this is for the Yahoo! Messenger™ network or “Gmail” or “googlemail” the Google Talk™ network. A list of domain names associated with the various IM networks is typically maintained by the network server 110.

Next, in step 722 the network server 110 establishes an SIP session between the mobile communications device 102 or call back telephone, and the VoIM client 130 over the IM network determined in step 720. The SIP session is established between the SIP Softswitch/Media Gateway 412 and the IM/VoIP gateway 416. The IM/VoIP gateway 416 connects to the VoIM client 130. The PSTN access gateway 408 connects with the Softswitch/Media Gateway. The SIP Softswitch/Media Gateway 412 makes the connection between the SIP Softswitch/Media Gateway 412 and the IM/VoIP gateway 416 which creates the chain from end to end. The network interconnect softswitch 304 (FIG. 3) performs signalling and protocol conversion to connect the mobile communications device 102 and VoIM client 130 over the IM network (via the Softswitch/Media Gateway 412 (FIG. 4) and IM/VoIP gateway 416 (FIG. 4)) network. The inbound call from the mobile communications device 102 or call back telephone is then bridged with the destination VoIM client 130 via the local access gateway 108.

The IM/VoIP gateway 416 transcodes SIP-compatible voice data packets from the VoIP gateway 108 into voice data packets that are compatible with the respective VoIM networks in accordance with the networks' respective encodation protocol. After transcoding the voice data packets into a format that is compatible with the respective VoIM network, the transcoded voice data packets can be transmitted to the respective VoIM network The IM/VoIP gateway 416 also transcodes voice data packets received from the respective VoIM networks into SIP-compatible voice data packets for transmission to the VoIP gateway 108 and from the gateway 108 to the caller via the mobile communications device 102 or call back telephone.

Next, in step 724 the call is connected to the destination VoIM network determined in step 720 at the destination IM address where it is answered by the person receiving the call using a VoIM client 130 on a computer or other computing device. This call is connected to the VoIM network via the network interconnect softswitch 304. Once the destination contact answers via the VoIM client 130, the call is connected. The call is placed by the smart route dialling network 111 by routing the call from the VoIP gateway 108 to the appropriate VoIM network server determined in step 720 via the network interconnect softswitch 304 (FIG. 3).

Next, in step 726 the call is automatically terminated by the smart route dialling gateway 108 when one party to hangs up or ends the call and the operations 700 end.

While the operations 500, 600 and 700 have been described as occur within a provided order, it will be appreciated to persons skilled in the art that some of the steps may be provided in a different order provided that the result of changed order of any given step will not prevent or impart the occurrence subsequent steps.

It will be appreciated to persons skilled in the art that various alterations, modifications and variations to the particular embodiments described herein are possible. For example, the destination identifier (be it a numeric telephonic phone, SIP URI, or an IM address) may be not be a contact in the contact list and therefore may be provided via respective user input rather than being selected from the contact list 301 as described in the operations 500, 600, and 700. Further, while calls have been discussed as having a caller and a single contact as the destination, it will be appreciate that the smart route dialling method and system of the present application may be adapted for use with conference call.

Although smart route dialling methods have been described in the context of use on a mobile communication device, these methods may also be implemented via a computer 101 (FIG. 1) connected to the communications system 100 via the Internet 112, and having a suitable Web browser such as Internet Explorer™ from Microsoft Corporation and/or a Java™ application or applet installed on the computer 101. A computer 101 having the necessary technical capabilities of connecting to the Internet in this manner would be readily apparent to a person skilled in the art and will not be described here. When using a computer 101, the user must typically use a call back number in order to place the call. The use of a computer 101 allows use to connect to the smart route dialling network GUI allows users who do not have a mobile phone/mobile communications device with capabilities for displaying a Web browser and/or a Java™ application or applet to use the smart route dialling network 111. The call back number allows the users to connect the call using a telephone number such as their mobile phone, or home or office telephone (which may be a PSTN or VoIP phone (which be a hardware based VoIP phone or SIP client/VoIP softphone/SIP softphone).

Alternatively, if a computer 101 having the necessary technical capabilities of connecting to the Internet via a Web browser and/or a Java™ application or applet may use the smart route dialling network 111 without call back if the computer has a SIP client or VoIP softphone/SIP softphone, in which case the smart route dialling GUI may be accessed from the computer 101 and the call connected directly from the computer the via SIP client or VoIP softphone/SIP softphone.

Alternatively, a computer 101 or mobile communications device 102 having the necessary technical capabilities of connecting to the Internet via a Web browser and/or a Java™ application or applet may use the smart route dialling network 111 may be used to instruct the VoIP gateway 108 that it will receive an inbound call from a given “call in” telephone number which the user has selected rather having the VoIP gateway 108 perform a call back, providing the destination identifier (i.e., destination telephone number, SIP URI, or IM address), and instructing the gateway 108 to call the destination identifier once the inbound call has been received. For example, a call may be set up from the Web browser on a PC and the call may be made using call-in/call back from a desk phone adjacent the PC or other phone.

In sum, various embodiments of the method and system of smart route dialling will be appreciated by a person of ordinary skill in the art. To connect to the system, a suitable computing device for connected to the smart route dialling network 111 and providing the smart route dialling GUI for instructing the network server 110 and/or VoIP gateway 108 is required, as well as a communications device (such as a PSTN phone, mobile phone or mobile communications device 102, VoIP hardware phone or VoIP/SIP softphone) to connect to the gateway 108 (via call in or call back from the gateway 106). The computing device and communications device may be, but do not have to be, the same device. For example, as above, the call may be set up from the Web browser on a PC and the call may be made using call-in/call back from a desk phone adjacent the PC or other phone.

While the present application is primarily described as a method, a person of ordinary skill in the art will understand that the present application is also directed to a communications device (such as the mobile communications device described above), for carrying out the disclosed method and including components for performing each described method step, be it by way of hardware components, a computer programmed by appropriate software to enable the practice of the disclosed method, by any combination of the two, or in any other manner. Moreover, an article of manufacture for use with the apparatus, such as a pre-recorded storage device or other similar computer readable medium including program instructions recorded thereon, or a computer data signal carrying computer readable program instructions may direct an apparatus to facilitate the practice of the disclosed method. It is understood that such apparatus (i.e., a communications device such as the mobile communications device described above), articles of manufacture, and computer data signals also come within the scope of the present application.

In accordance with one embodiment of the present application, there is provided a graphical user interface (GUI) for performing the methods described herein, and for use on the communications device.

In accordance with another embodiment of the present application, there is provided a communications device having one or both of voice and data capabilities, the communications device being connectable to a communications network for transmitting and receiving voice data and other data over the communications network, communications device comprising: a processor for controlling the operation of the communications device; a communications subsystem operatively connected to the processor for communicating with the communications network; a memory operatively connected to the processor, the memory having data and instructions stored thereon to configure the communications device for implementing aspects of the method(s) of the present application on the communications device, as described above.

In accordance with a further embodiment of the present application, there is provided a communications system, comprising: a VoIP gateway, a network server connected to the VoIP gateway, and a communication device, such as a mobile communications device adapted for implementing aspects of the method(s) of the present application as described above, which connected to the VoIP gateway via a communications network.

The embodiments of the present application described above are intended to be examples only. Those of skill in the art may effect alterations, modifications and variations to the particular embodiments without departing from the intended scope of the present application. In particular, selected features from one or more of the above-described embodiments may be combined to create alternative embodiments not explicitly described, features suitable for such combinations being readily apparent to persons skilled in the art. The subject matter described herein in the recited claims intends to cover and embrace all suitable changes in technology.

1. A method for routing a call from a communications device having at least voice and data capabilities, the communications device being connected to a communications network for transmitting and receiving voice data and other data over the communications network, the method comprising the steps of:
selecting a destination identifier for the call, the destination identifier comprising one of: a landline telephone number, a mobile telephone number, an instant messaging (IM) address, and a session initiation protocol uniform resource indicator (SIP URI);
connecting the call to a Voice over Internet Protocol (VoIP) gateway; and
routing the call from the VoIP gateway to the destination identifier, comprising:
if the destination identifier is a landline telephone number, routing the call to a respective landline telephone associated with the destination identifier via a public switched telephone network (PSTN),
if the destination identifier is a mobile telephone number, routing the call to a respective mobile telephone associated with the destination identifier via a wireless communications network,
if the destination identifier is an IM address, routing the call to a respective IM voice network (VoIM) client via a VoIM network associated with the destination identifier, and
if the destination identifier is an SIP URI, routing the call to an SIP-compatible VoIP phone associated with the destination identifier via the Internet.

2. The method of claim 1, wherein the call is routed from the VoIP gateway to the destination identifier via at least one intermediary communications network.

3. The method of claim 1, wherein the VoIP gateway is connected to at least one PSTN, at least one wireless communications network, at least one VoIM network, and at least one SIP-compatible enabled VoIP network or VoIP phone for routing voice data compatible with SIP therebetween.

4. The method of claim 1, further comprising the steps of:
if the destination identifier is a landline or mobile phone number,
determining a home location associated with the communications device;
determining a current location of the communications device; and
converting the destination telephone number from a first format to a second format based on the home location of the communications device and the current location of the communications device, wherein the second format is the E.164 international dialling format.

5. The method of claim 4, wherein determining the home location comprises determining one of: a home country code, a home country code and area code, a home country code and city code; and wherein determining the current location comprises determining one of: a current country code, a current country code and area code, a current country code and city code.

6. The method of claim 4, wherein the converting is based on the home location, current location and a comparison to a database of country codes, area codes, city codes and local exchange codes.

7. The method of claim 4, wherein the communications device is a mobile communications device, the home location being provided by the user input on the mobile communications device or received from a user profile stored in a user account database accessible by mobile communications device.

8. The method of claim 4, wherein the current location of the mobile communications device is determined by user input on the mobile communications device.

9. The method of claim 4, wherein the communications device is a mobile communications device, the current location of the mobile communications device being determined in accordance with location information associated with the mobile communications device and provided by a location server.

10. The method of claim 4, wherein the communications device is a mobile communications device, the current location of the mobile communications device being determined in accordance with location information associated with the mobile communications device and provided by a Global Positioning System (GPS) or an assisted GPS.

11. The method of claim 1, wherein destination identifier is selected via respective user input on the communications device.

12. The method of claim 11, wherein the user input is a selection of a contact record from a contact list accessible on the communications device, the contact list being displayed in a graphical user interface (GUI) presented on a display of the communications device

13. The method of claim 1, wherein the destination identifier is selected in accordance with presence information associated with one or more possible destination identifiers.

14. The method of claim 1, wherein the destination identifier is selected in accordance with presence information associated with one or more destination identifiers of a contact record from a contact list accessible on the communications device.

15. The method of claim 14, wherein the contact list is stored locally on the communications device.

16. The method of claim 14, wherein the contact list is stored remotely on a network server.

17. The method of claim 1, further comprising:
if the selected destination identifier is a landline or mobile phone number, routing the call from the VoIP gateway to the destination identifier in accordance with least one least cost routing algorithm based on at least the location of the communications device and whether the destination telephone number is a landline or mobile phone number.

18. The method of claim 4, further comprising:
if the selected destination identifier is a landline or mobile phone number, and communications device is a mobile communications device,
determining a least cost route to the destination telephone number in accordance with at least one least cost routing algorithm based on the home location and current location of the mobile communications device, and whether the destination telephone number is a landline or mobile phone number; and
routing the call from the VoIP gateway to the destination identifier in accordance with determined the least cost route.

19. The method of claim 1, wherein the step of connecting the call to the VoIP gateway comprises calling the VoIP gateway from the communications device at a local access gateway number.

20. The method of claim 1, wherein the step of connecting the call to the VoIP gateway comprises receiving a call on the communications device from the VoIP gateway.

21. The method of claim 20, wherein the selection of the destination identifier occurs on a first device, and the connection of the call to the VoIP gateway occurs on a second device which is the communications device, wherein the communications device is a call back telephone, the phone number of the call back telephone being a designated call back number, the step of connecting the call to the VoIP gateway comprising receiving a call on the call back telephone at the designated call back number.

22. The method of claim 1, wherein the communications device is mobile communications device, the step of connecting the call to the VoIP gateway comprising:
determining a local access gateway number based on the current location of the mobile communications device; and
calling the VoIP gateway at the local access gateway number from the mobile communications device.

23. A method for calling a phone number from a mobile communications device connected to a wireless communications network, the method comprising the steps of:
receiving on the mobile communications device user input providing a destination telephone number for dialling from the mobile communications device, the destination telephone number being in a first format;
determining a home location associated with the mobile communications device;
determining a current location of the mobile communications device; and
converting the destination telephone number from a first format to a second format based on the home location of the mobile communications device and the current location of the mobile communications device, wherein the second format is the E.164 international dialling format.

24. The method of claim 23, wherein determining the home location comprises determining one of: a home country code, a home country code and area code, a home country code and city code; and wherein determining the current location comprises determining one of: a current country code, a current country code and area code, a current country code and city code.

25. The method of claim 23, wherein the converting is based on the home location, current location and a comparison to a database of country codes, area codes, city codes and local exchange codes.

26. The method of claim 23, wherein the home location is provided by the user input on the mobile communications device or received from a user profile stored in a user account database.

27. The method of claim 23, wherein the current location of the mobile communications device is determined by user input on the mobile communications device.

28. The method of claim 23, wherein the current location of the mobile communications device is determined in accordance with location information associated with the mobile communications device and provided by a location server.

29. The method of claim 23, wherein the current location of the mobile communications device is determined in accordance with location information associated with the mobile communications device and provided by a Global Positioning System (GPS) or an assisted GPS.

30. The method of claim 23, further comprising:
directly calling the converted destination telephone number from the mobile communications device via the wireless communications network; and
routing the call via the wireless communications network to the destination telephone number.

31. The method of claim 23, further comprising:
calling a local access gateway from the mobile communications device at a local access gateway number; and
routing the call via the local access gateway number to the destination telephone number.

32. The method of claim 23, further comprising:
determining a local access gateway number based on the current location of the location of the mobile communications device;
calling the local access gateway number from the mobile communications device at the local access gateway number; and
routing the call via the local access gateway to the destination telephone number.

33. The method of claim 23, further comprising:
determining a least cost route to the destination telephone number in accordance with at least one least cost routing algorithm based on the home location and current location of the mobile communications device, and whether the destination telephone number is a landline or mobile phone number; and
routing the call from the local access gateway to the destination telephone number in accordance with determined the least cost route.

34. The method of claim 23, further comprising:
receiving a call on the communications device from a local access gateway; and
routing the call via the local access gateway to the destination telephone number.
